(19) United States
(12) Patent Application Publication
(10) Pub. No.: US 2009/0300291 A1
(43) Pub. Date: Dec. 3, 2009

(54) Implementing Cache Coherency and Reduced Latency Using Multiple Controllers for Memory System

(76) Inventors: Gerald Keith Bartley, Rochester, MN (US); Darryl John Becker, Rochester, MN (US); John Michael Borkenhagen, Rochester, MN (US); Paul Eric Dahlen, Rochester, MN (US); Philip Raymond Germann, Oronoco, MN (US); William Paul Hovis, Rochester, MN (US); Mark Owen Maxson, Mantorville, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 12/132,109

(22) Filed: Jun. 3, 2008

(51) Int. Cl. G06F 12/08

(52) U.S. Cl. 711/141; 711/E12.026

(57) ABSTRACT

A method and apparatus implement cache coherency and reduced latency using multiple controllers for a memory system, and a design structure is provided on which the subject circuit resides. A first memory controller uses a first memory as its primary address space, for storage and fetches. A second memory controller is also connected to the first memory. A second memory controller uses a second memory as its primary address space, for storage and fetches. The first memory controller is also connected to the second memory. The first memory controller and the second memory controller, for example, are connected together by a processor communications bus. A request and send sequence of the invention sends data directly to a requesting memory controller eliminating the need to re-route data back through a responding controller, and improving the latency of the data transfer.

### RELATED APPLICATION

A related United States patent application assigned to the present assignee is being filed on the same day as the present patent application including:

U.S. patent application Ser. No. ______, by Gerald Keith Bartley, and entitled “IMPLEMENTING REDUNDANT MEMORY ACCESS USING MULTIPLE CONTROLLERS FOR MEMORY SYSTEM”.

### FIELD OF THE INVENTION

The present invention relates generally to the data processing field, and more particularly, relates to a method and apparatus for implementing cache coherency and reduced latency using multiple controllers for a memory system, and a design structure on which the subject circuit resides.

### DESCRIPTION OF THE RELATED ART

As systems become more complex, memory latency becomes a key performance bottleneck. The ability to move data efficiently from dynamic random access memories (DRAMs) to processors could significantly improve overall system performance.

FIG. 1 illustrates a conventional memory system. A first processor or memory controller 1 includes a data path 1 and a primary memory control path 1 to a chain of dedicated memory. A second processor or memory controller 2 includes a data path 2 and a primary memory control path 2 to a separate chain of dedicated memory. The two processors or memory controllers 1, 2 are connected by a processor communication bus.

Typically cache coherence requirements prohibit simply connecting another processor to a bank of memory. For example, in a simple case such as a multiprocessor system, if one processor has requested a block of data for an operation, another processor cannot use the same data until the first one has completed its operation and returned the data to the memory bank, or invalidated the data in the memory. This requirement can be avoided by allowing each controller to independently maintain its own segregated memory bank, such as illustrated in the prior art memory system of FIG. 1. A significant problem with this solution is that for another processor/controller to access the data, typically a high-latency sequence must occur as follows:

1) The requesting controller must send a request to the responding controller for a particular data set.

2) The responding controller must send a request to DRAMs in its memory to read back the data.

3) The DRAMs send the data back to the responding controller.

4) The responding controller must re-route the data back to the requesting controller.

5) The requesting controller must notify the responding controller of any change to the data, as a result of processing operations.

U.S. patent application Ser. No. 11/758,732 filed Jun. 6, 2007, and assigned to the present assignee, discloses a method and apparatus for implementing redundant memory access using multiple controllers on the same bank of memory. A first memory controller uses the memory as its primary address space, for storage and fetches. A second redundant controller is also connected to the same memory. System control logic is used to notify the redundant controller of the need to take over the memory interface. The redundant controller initializes if required and takes control of the memory. The memory only needs to be initialized if the system has to be brought down and restarted in the redundant mode.

While the above-identified patent application provides improvements over the prior art arrangements, there is no simultaneous access of the memory by more than one controller. When a primary controller fails, the redundant controller assumes full control and access to the memory, providing an alternate access path to the memory.

It is highly desirable to be able to allow multiple controllers to quickly and efficiently gain access to memory, which is dedicated to and controlled by another processor or controller.

A need exists for an effective mechanism that enables implementing cache coherency and reduced latency using multiple controllers for a memory system. A more efficient method of routing data between memories, such as caches is highly desirable, while maintaining current conventional cache coherence requirements.

### SUMMARY OF THE INVENTION

Principal aspects of the present invention are to provide a method and apparatus for implementing cache coherency and reduced latency using multiple controllers for a memory system, and a design structure on which the subject circuit resides. Other important aspects of the present invention are to provide such method and apparatus for implementing cache coherency and reduced latency using multiple controllers for a memory system substantially without negative effect and that overcome many of the disadvantages of prior art arrangements.

In brief, a method and apparatus for implementing cache coherency and reduced latency using multiple controllers for a memory system, and a design structure on which the subject circuit resides are provided. A first memory and a memory are connected to multiple memory controllers. A first memory controller uses the first memory as its primary address space, for storage and fetches. A second memory controller is also connected to the first memory. The second memory controller uses the second memory as its primary address space, for storage and fetches. The first memory controller is also connected to the second memory. The first memory controller and the second memory controller, for example, are connected together by a processor communications bus. The first memory controller requests access to data in the second memory of the second memory controller. The second memory controller routes the request to the second memory to send data to the first memory controller. The second memory sends the data directly to the first memory controller. The first memory controller notifies the second memory controller of any change to the data for cache coherence requirements.

In accordance with features of the invention, the request and send sequence sends the data directly to the requesting memory controller eliminating the need to re-route data back through the responding controller, improving the latency of the data transfer.

In accordance with features of the invention, by avoiding the transfer through the responding controller, bandwidth through the responding controller may be saved for other transfers, further improving and optimizing performance.

In accordance with features of the invention, the first memory and the second memory include a daisy chain of memory chips each connected to the first memory controller and the second memory controller at respective ends of the daisy chains.

In accordance with features of the invention, the first memory and the second memory include a plurality of dynamic random access memory modules (DRAMs) arranged, for example, as dual inline memory module (DIMM) circuit cards in a fully-buffered DIMM (FBDIMM).

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representation illustrating a prior art memory system;

FIGS. 2, and 3 are block diagram representations each respectively illustrating an alternative memory system in accordance with the preferred embodiment;

FIG. 4 illustrates exemplary steps performed by each exemplary memory system in accordance with the preferred embodiment; and

FIG. 5 is a flow diagram of a design process used in semiconductor design, manufacturing, and/or test.

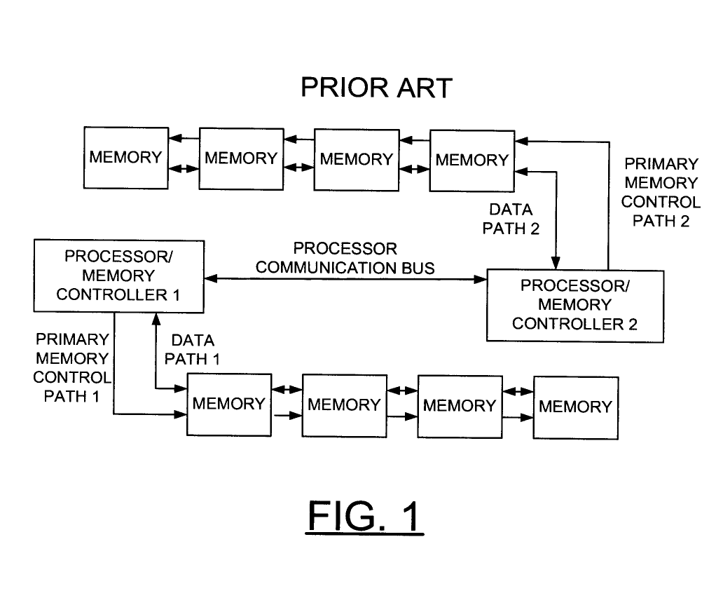

### DETAILED DESCRIPTION OF THE PREFERRED EMBODIMENTS

In accordance with features of the invention, a method and apparatus enable implementing cache coherency and reduced latency using multiple controllers for a memory system, while maintaining current conventional cache coherence schemes.

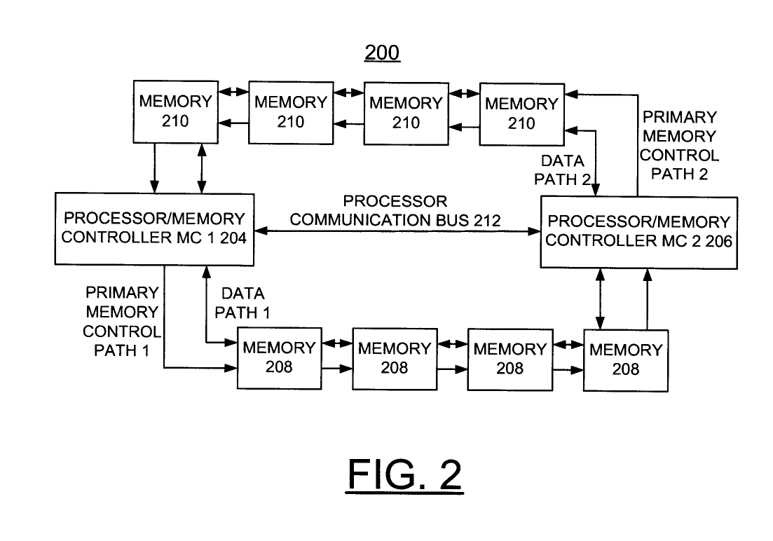

Having reference now to the drawings, in FIG. 2, there is shown a memory system generally designated by the reference character 200 in accordance with the preferred embodiment.

Memory system 200 is a dynamic random access memory (DRAM) system 200. DRAM system 200 includes a first processor or memory controller (MC 1) 204 and a second processor or memory controller (MC 2) 206. The first memory controller MC 1, 204 and the second redundant memory controller MC2, 206, for example, includes an integrated microprocessor and memory controller, such as a processor system in a package (SIP).

Each of the two controllers MC1, 204 and MC2, 206 includes dedicated memory. The first processor or memory controller MC1, 204 includes a data path 1 and a primary memory control path 1 to a chain of memory chips or modules 208, such as dynamic random access memory (DRAM) chips or modules 208. The second processor or memory controller MC2, 206 includes a data path 2 and a primary memory control path 2 to a separate chain of memory chips or modules 210, such as dynamic random access memory (DRAMs) 210. The memory controllers MC1, 204 and MC2, 206 are connected together by a processor communications bus 212.

In accordance with features of the invention, in addition to the connection of each controller MC1, 204; MC2, 206 to its bank of memory 208, 210, an additional through bus connection is made to the other controller MC1, 204; MC2, 206. The data path 1 and a primary memory control path 1 to the chain of memory 208 extend to the other controller MC2, 206. The data path 2 and a primary memory control path 2 to the chain of memory 210 extend to the other controller MC1, 204. This bus is a full-width data interface, just like the one to the primary controller.

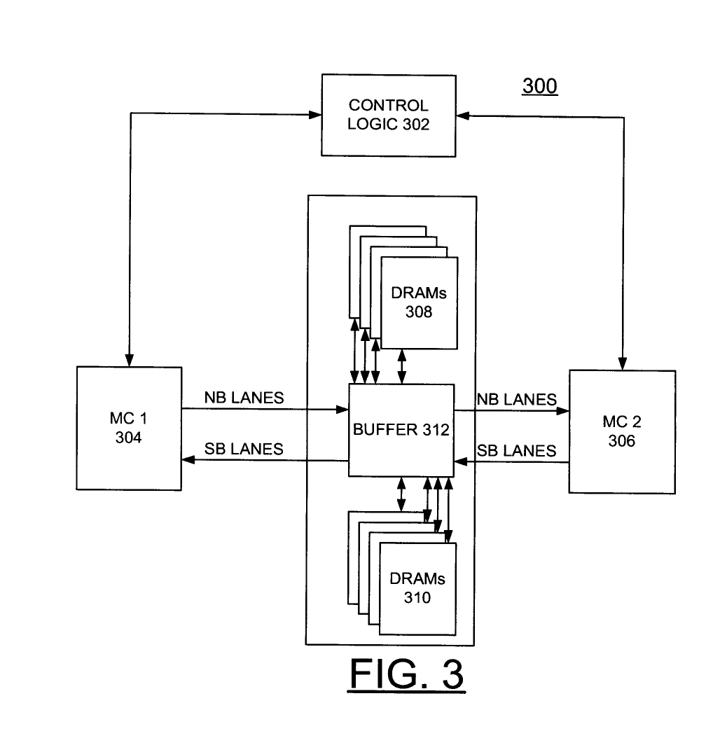

Referring also to FIG. 3, there is shown another memory system generally designated by the reference character 300 in accordance with the preferred embodiment.

Memory system 300 is a dynamic random access memory (DRAM) system 300. DRAM system 300 includes a control logic circuit 302 is connected to each of a first processor or memory controller (MC 1) 304 and a second processor or memory controller (MC 2) 306. Optionally the memory controllers MC1, 304 and MC2, 306 are connected together by a processor communications bus.

Each of the memory controllers MC 1, MC 2, 304, 306 optionally can be physically included with a respective processor within a processor package or system in a package (SIP).

For example, the first memory controller MC 1, 304 includes dedicated memory chips or modules 308, and the second memory controller MC 2, 306 includes dedicated memory chips or modules 310. The control logic circuit 302 is provided to send requests between and to notify the memory controllers MC 1, MC 2, 304, 306 with respect to changed data, as required to maintain cache coherency rules.

Each of the memory controllers MC 1, MC 2, 304, 306 is connected to a memory buffer 312 via northbound (NB) and southbound (SB) lanes. Memory buffer 312 is coupled to the plurality of DRAMs 308, 310, arranged, for example, as dual inline memory module (DIMM) circuit cards. Memory system 300 is a fully-buffered DIMM (FBDIMM).

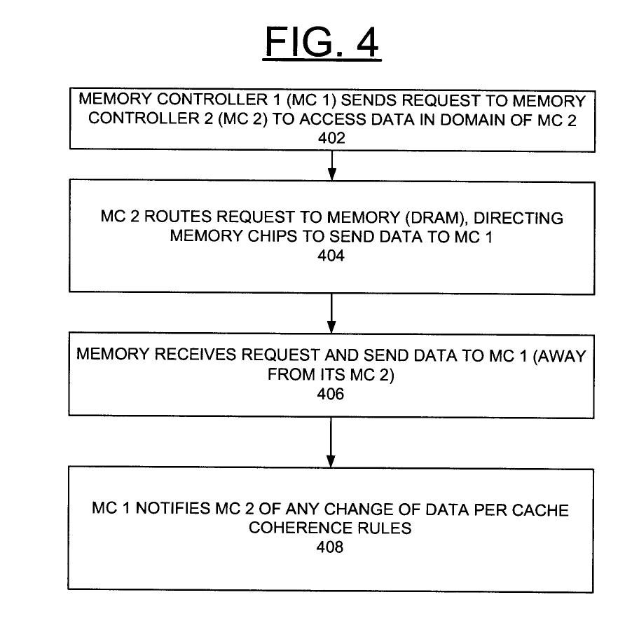

Exemplary operation of the memory system 200 and the memory system 300, is illustrated and described with respect to the exemplary steps shown in the flow chart of FIG. 4.

Referring now to FIG. 4, there are shown exemplary steps performed by each exemplary memory system 200, 300 in accordance with the preferred embodiment. As indicated at a block 402, a requesting controller, such as, the first memory controller 1 (MC 1) requests access to data in the second memory of a responding controller, such as, the second memory controller MC 2.

As indicated at a block 404, the second memory controller MC 2 routes the request to the second memory to send data to the first memory controller MC1. The MC 2 routes the request to the second memory, such as memory 210 in FIG. 2, or memory 310 in FIG. 3.

As indicated at a block 406, the second memory sends the data directly to the first memory controller MC1. The first memory controller MC 1 notifies the second controller MC 2 of any change to the data for cache coherence requirements as indicated at a block 408.

In accordance with features of the invention, memory system 200 and memory system 300 have the ability to receive data directly from the memory of another controller during normal system operation. The request and send sequence of the method of the invention sends the data directly to the requesting memory controller and eliminates the need to re-route data back through the responding controller, improving the latency of the data transfer. By avoiding the transfer through the responding controller, bandwidth through the responding controller advantageously is saved for other transfers, further improving and optimizing performance. In a more complicated sequence, the responding controller advantageously determines which path is lower latency, either routing back through the primary controller, or moving the data upstream directly to the requesting controller. Each memory controller maintains coherence of its dedicated memory, according to current conventional methods.

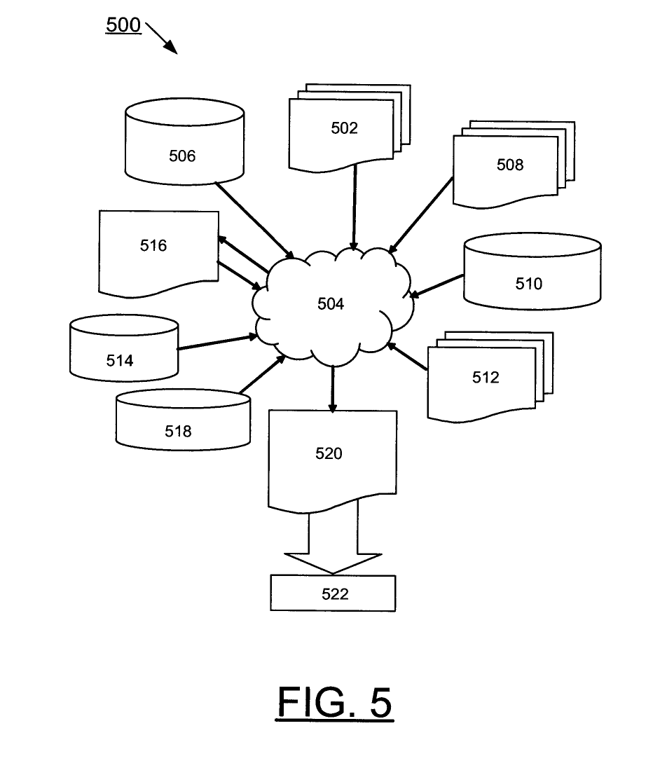

FIG. 5 shows a block diagram of an example design flow 500. Design flow 500 may vary depending on the type of IC being designed. For example, a design flow 500 for building an application specific IC (ASIC) may differ from a design flow 500 for designing a standard component. Design structure 502 is preferably an input to a design process 504 and may come from an IP provider, a core developer, or other design company or may be generated by the operator of the design flow, or from other sources. Design structure 502 comprises circuits 100, 200, 300, 400, 500, 600, 700 in the form of schematics or HDL, a hardware-description language, for example, Verilog, VHDL, C, and the like. Design structure 502 may be contained on one or more machine readable medium. For example, design structure 502 may be a text file or a graphical representation of circuits 200, 300. Design process 504 preferably synthesizes, or translates, circuits 200, 300 into a netlist 506, where netlist 506 is, for example, a list of wires, transistors, logic gates, control circuits, I/O, models, etc. that describes the connections to other elements and circuits in an integrated circuit design and recorded on at least one of machine readable medium. This may be an iterative process in which netlist 506 is resynthesized one or more times depending on design specifications and parameters for the circuits.

Design process 504 may include using a variety of inputs; for example, inputs from library elements 508 which may house a set of commonly used elements, circuits, and devices, including models, layouts, and symbolic representations, for a given manufacturing technology, such as different technology nodes, 32 nm, 45 nm, 90 nm, and the like, design specifications 510, characterization data 512, verification data 514, design rules 516, and test data files 518, which may include test patterns and other testing information. Design process 504 may further include, for example, standard circuit design processes such as timing analysis, verification, design rule checking, place and route operations, and the like. One of ordinary skill in the art of integrated circuit design can appreciate the extent of possible electronic design automation tools and applications used in design process 504 without deviating from the scope and spirit of the invention. The design structure of the invention is not limited to any specific design flow.

Design process 504 preferably translates an embodiment of the invention as shown in FIGS. 2-4 along with any additional integrated circuit design or data (if applicable), into a second design structure 520. Design structure 520 resides on a storage medium in a data format used for the exchange of layout data of integrated circuits, for example, information stored in a GDSII (GDS2), GL1, OASIS, or any other suitable format for storing such design structures. Design structure 520 may comprise information such as, for example, test data files, design content files, manufacturing data, layout parameters, wires, levels of metal, vias, shapes, data for routing through the manufacturing line, and any other data required by a semiconductor manufacturer to produce an embodiment of the invention as shown in FIGS. 2-4. Design structure 520 may then proceed to a stage 522 where, for example, design structure 520 proceeds to tape-out, is released to manufacturing, is released to a mask house, is sent to another design house, is sent back to the customer, and the like.

While the present invention has been described with reference to the details of the embodiments of the invention shown in the drawing, these details are not intended to limit the scope of the invention as claimed in the appended claims.

What is claimed is:

1. An apparatus for implementing cache coherency and reduced latency in a memory system comprising:
a first memory and a second memory;
a first memory controller and a second memory controller, each of said first memory controller and said second memory controller connected to both said first memory and said second memory; said first memory controller and said second memory connected together;
said first memory controller using said first memory as its primary address space, for storage and fetches and maintaining cache coherency;
said second memory controller using said second memory as its primary address space, for storage and fetches and maintaining cache coherency;
said first memory controller sending a request to said second memory controller to access to data in said second memory;
said second memory controller routing the request to said second memory to send data to said first memory controller;
said second memory sending the data to said first memory controller; and
said first memory controller notifying the second memory controller of any change to the data for cache coherence requirements.

2. The apparatus for implementing cache coherency and reduced latency as recited in claim 1 wherein said second memory controller sending a request to said first memory controller to access to data in said second memory;
said first memory controller routing the request to said first memory to send data to said second memory controller;
said first memory sending the data directly to said second memory controller; and
said second memory controller notifying said first memory controller of any change to the data for cache coherence requirements.

3. The apparatus for implementing cache coherency and reduced latency as recited in claim 1 wherein said first memory and said second memory include dynamic random access memory (DRAM).

4. The apparatus for implementing cache coherency and reduced latency as recited in claim 1 includes a processor communications bus connecting said first memory controller and said second memory.

5. The apparatus for implementing cache coherency and reduced latency as recited in claim 1 wherein said first memory and said second memory include a daisy chain of memory chips.

6. The apparatus for implementing cache coherency and reduced latency as recited in claim 5 wherein said first memory controller and said second memory controller are connected at respective ends of each said daisy chain of said first memory and said second memory.

7. The apparatus for implementing cache coherency and reduced latency as recited in claim 6 includes a full-width data bus connection to each of said first memory controller and said second memory controller at respective ends of each said daisy chain.

8. The apparatus for implementing cache coherency and reduced latency as recited in claim 6 wherein said data is directly sent to said first memory controller responsive to said request to said second memory controller to access to data in said second memory proximate to said respective end of said daisy chain connected to said second memory controller.

9. The apparatus for implementing cache coherency and reduced latency as recited in claim 1 wherein said first memory and said second memory include a data buffer coupled to a plurality of memory chips.

10. The apparatus for implementing cache coherency and reduced latency as recited in claim 9 wherein said plurality of memory chips include dynamic random access memory (DRAM) arranged as buffered memory with multiple dual inline memory module (DIMM) circuit cards.

11. The apparatus for implementing cache coherency and reduced latency as recited in claim 10 wherein said first memory controller and said second memory controller includes an integrated microprocessor and memory controller.

12. A method for implementing cache coherency and reduced latency in a memory system including a first memory and a second memory; a first memory controller and a second memory controller, each of said first memory controller and said second memory controller connected to both said first memory and said second memory; and said first memory controller and said second memory connected together; said method comprising:
using said first memory as a primary address space, for storage and fetches for said first memory controller and said first memory controller maintaining cache coherency for said first memory;
using said second memory as a primary address space, for storage and fetches for said second memory controller and said second memory controller maintaining cache coherency for said second memory;
sending a request to said second memory controller to access to data in said second memory with said first memory controller;
routing the request to said second memory to send data to said first memory controller with said second memory controller;
sending the data from said second memory to said first memory controller; and
notifying the second memory controller of any change to the data with said first memory controller.

13. The method for implementing cache coherency and reduced latency as recited in claim 12 further includes sending a request to said first memory controller to access to data in said first memory with said second memory controller;
routing the request to said first memory to send data to said second memory controller with said first memory controller;
sending the data from said first memory to said second memory controller; and
notifying the first memory controller of any change to the data with said second memory controller.

14. The method for implementing cache coherency and reduced latency as recited in claim 12 includes providing a respective daisy chain of dynamic random access memory (DRAM) for said first memory and said second memory, and connecting said first memory controller and said second memory controller at respective ends of each said daisy chain of said first memory and said second memory.

15. The method for implementing cache coherency and reduced latency as recited in claim 12 includes providing dynamic random access memory (DRAM) for said first memory and said second memory, providing a buffer coupled between said first memory and said second memory and said first memory controller and said second memory controller.

16. The method for implementing cache coherency and reduced latency as recited in claim 15 includes sending data directly to said first memory controller responsive to said request to said second memory controller to access to data in said second memory proximate to said respective end of said daisy chain connected to said second memory controller

17. A design structure embodied in a machine readable medium used in a design process, the design structure comprising:
a memory system including a first memory and a second memory;
a first memory controller and a second memory controller, each of said first memory controller and said second memory controller connected to both said first memory and said second memory; said first memory controller and said second memory connected together;
said first memory controller using said first memory as its primary address space, for storage and fetches and maintaining cache coherency;
said second memory controller using said second memory as its primary address space, for storage and fetches and maintaining cache coherency;
said first memory controller sending a request to said second memory controller to access to data in said second memory;
said second memory controller routing the request to said second memory to send data to said first memory controller;
said second memory sending the data to said first memory controller;
said first memory controller notifying the second memory controller of any change to the data for cache coherence requirements; and wherein the design structure is used in a semiconductor system manufacture, and produces said memory system.

18. The design structure of claim 17, wherein the design structure comprises a netlist, which describes the memory system.

19. The design structure of claim 17, wherein the design structure resides on storage medium as a data format used for the exchange of layout data of integrated circuits.

20. The design structure of claim 17, wherein said first memory and said second memory include dynamic random access memory (DRAM).
